(19) United States
(12) Patent Application Publication
(10) Pub. No.: US 2015/0154482 A1
(43) Pub. Date: Jun. 4, 2015

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Ryoya Kawai, Kawasaki-shi (JP)

(21) Appl. No.: 14/553,006

(22) Filed: Nov. 25, 2014

(30) Foreign Application Priority Data
Nov. 29, 2013 (JP) 2013-248455

(51) Int. Cl. G06K 15/00; H04N 1/00

(52) U.S. Cl. CPC G06K 15/40; H04N 1/00307; H04N 2201/0094; H04N 2201/0081; H04N 2201/0082; H04N 2201/0072; H04N 2201/0096; H04N 2201/0055

(57) ABSTRACT

An information processing apparatus which controls a device to execute predetermined processing includes an acquisition unit configured to acquire position information for identifying a position of the information processing apparatus at which the information processing apparatus causes the device to execute the predetermined processing, and an identifying unit configured to, after the predetermined processing is executed by the information processing apparatus according to a first control, and in a case where the predetermined processing is newly executed by the information processing apparatus according to a second control, identify a device for executing the predetermined processing according to the second control based on the position information corresponding to the first control acquired by the acquisition unit and position information of the information processing apparatus corresponding to the second control.

### BACKGROUND OF THE INVENTION

1. Field of the Invention

The present invention relates to an information processing apparatus for causing a device to execute predetermined processing, an information processing method, and a storage medium.

2. Description of the Related Art

When a user prints an image or reads a document through a printer or a scanner by using a mobile terminal, such as a portable smartphone, there has been provided a technique for automatically detecting a printer or a scanner for executing printing or reading. Japanese Patent Application Laid-Open No. 2007-094554 discusses a technique for displaying a list of usable printers according to a detection result of detecting printers having functions frequently used by a user on a network. Specifically, usage frequency of each printing function used by the user is measured and stored. Then, a printer having frequently-used functions is identified from among the printers detected in the network, and the printer is prioritized and displayed on the list.

However, in the above-described conventional technique, a frequently-used printer is prioritized regardless of a place where the user uses the mobile terminal. Therefore, the frequently-used printer away from the place where the user instructs printing may be identified as a printer that is to be used for the printing operation.

### SUMMARY OF THE INVENTION

According to an aspect of the present invention, an information processing apparatus which controls a device to execute predetermined processing includes an acquisition unit configured to acquire position information for identifying a position of the information processing apparatus at which the information processing apparatus causes the device to execute the predetermined processing, and an identifying unit configured to, after the predetermined processing is executed by the information processing apparatus according to a first control, and in a case where the predetermined processing is newly executed by the information processing apparatus according to a second control, identify a device for executing the predetermined processing according to the second control based on the position information corresponding to the first control acquired by the acquisition unit and position information of the information processing apparatus corresponding to the second control.

Further features of the present invention will become apparent from the following description of exemplary embodiments with reference to the attached drawings.

### BRIEF DESCRIPTION OF THE DRAWINGS

FIG. 1 is a diagram illustrating a configuration of a printing system according to an exemplary embodiment.

FIG. 2 is a diagram illustrating a software configuration of a mobile terminal.

FIG. 3 is a diagram illustrating a print setting screen.

FIGS. 4A and 4B are flowcharts each illustrating an example of processing executed by the printing system according to the present exemplary embodiment.

FIG. 5 is a diagram illustrating an example of a printer list stored in a storage device by a usage history storage unit.

FIG. 6 is a diagram illustrating an example of a list displayed on a display unit.

FIG. 7 is a diagram illustrating capability information of a printer stored in the storage device.

FIG. 8 is a diagram illustrating a name of an access point corresponding to a printer stored in the storage device.

FIG. 9 (consisting of FIG. 9A and FIG. 9B) is a flowchart illustrating an example of processing executed by the printing system according to the present exemplary embodiment.

FIG. 10 is a diagram illustrating an example of a printer list.

### DESCRIPTION OF THE EMBODIMENTS

Various exemplary embodiments, features, and aspects of the invention will be described in detail below with reference to the drawings.

According to an exemplary embodiment, a description will be given to an example of printing control in which a mobile terminal as one example of an information processing apparatus causes a printer as one example of a device to execute printing. Specifically, a description will be given to an example of the processing in which the mobile terminal identifies a printer for newly executing printing based on a position of the mobile terminal at which the mobile terminal has executed printing through a printer and a position of the mobile terminal at which the mobile terminal newly executes printing. More specifically, in a case where the mobile terminal has previously executed printing in a vicinity of a position where the mobile terminal newly executes printing, the mobile terminal prioritizes and selects the printer that has executed printing at the point as a printer for executing printing. Details of the processing according to the present exemplary embodiment will be described.

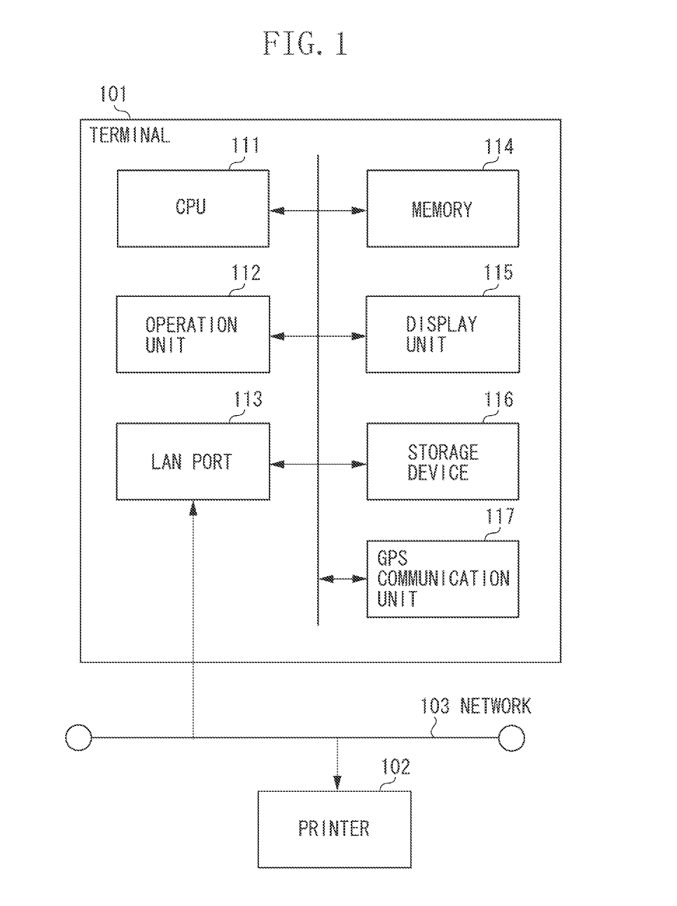

FIG. 1 is a diagram illustrating a configuration of a printing system according to the present exemplary embodiment. In FIG. 1, the printing system according to the present exemplary embodiment connects a mobile terminal 101 and a printer 102 via a network 103. Although one mobile terminal 101 and one printer 102 are connected to each other in the network configuration illustrated in FIG. 1, other printers or mobile terminals which are not illustrated in FIG. 1 may be also connected thereto via the network 103. Further, for example, the mobile terminal 101 may be a mobile phone, a smartphone, a tablet-type terminal, or various devices, such as a notebook personal computer (PC). Furthermore, the processing according to the present exemplary embodiment is not only applicable to an apparatus carried by the user but also applicable to various information processing apparatuses, such as a desktop PC.

In the printing system according to the present exemplary embodiment, the mobile terminal 101 and the printer 102 communicate with each other according to a transmission control protocol/internet protocol (TCP/IP). The mobile terminal 101 includes a central processing unit (CPU) 111 which executes general control of the mobile terminal 101, an operation unit 112 through which the user provides an instruction to the mobile terminal 101, and a local area network (LAN) port 113 which connects the mobile terminal 101 to the network 103. Further, the mobile terminal 101 includes a memory 114, a display unit 115, such as a liquid crystal panel, and a storage device 116, such as a flash memory. Furthermore, the mobile terminal 101 includes a global positioning system (GPS) function for receiving GPS information.

The memory 114 is a random access memory (RAM) serving as a work area of the CPU 111. Various control programs, such as an application described below and an operating system (hereinafter, referred to as “OS”) are stored in the storage device 116. The LAN port 113 is connected to the network 103, so as to connect the mobile terminal 101 to the printer 102 via the network 103.

The LAN port 113 and the network 103 may be connected to each other through a wireless connection, such as a wireless LAN or Bluetooth (registered trademark), or a wired connection, such as a universal serial bus (USB).

In the above-described configuration, the CPU 111 can control the mobile terminal 101 by reading the control program from the storage device 116 to the memory 114 and executing the control program on the memory 114. For example, the CPU 111 receives a user's instruction input to the operation unit 112, reads out data from the storage device 116 according to the instruction, and displays an image on the display unit 115 based on the data. The CPU 111 can also display a screen which allows the user to specify the printer 102 as a printer for executing printing on the display unit 115.

The operation unit 112 serves as an operation device which allows the user to input an instruction. For example, the operation unit 112 may be buttons pressed by the user, a touch panel touched by the user with his/her finger or a stylus pen, or may include both of them. The touch panel may be arranged on a front surface of the display unit 115, while a guide display touched by the user may be displayed on the display unit 115. A pressure-sensitive type or an electrostatic-type touch panel for the touch panel can be employed. When the electrostatic-type touch panel is employed, even if a user's finger or the stylus pen does not make contact with the touch panel, an instruction can be input thereto by moving the finger or the stylus pen close to or away from the touch panel.

Further, the mobile terminal 101 can identify a position of the mobile terminal 101 by using a global positioning system (GPS). Specifically, the mobile terminal 101 includes a GPS communication unit 117, and the GPS communication unit 117 receives radio waves from a plurality of satellites (GPS satellites). Then, the mobile terminal 101 calculates a distance between each satellite and the mobile terminal 101 from the radio waves received therefrom, and identifies a position that corresponds to the calculated distances between the mobile terminal 101 and the plurality of the satellites as a position of the mobile terminal 101. For example, when the mobile terminal 101 receives radio waves from four or more satellites, the mobile terminal 101 can calculate a position in a three-dimensional space. Specifically, the mobile terminal 101 can calculate latitude, longitude, and altitude of the mobile terminal 101.

Further, the radio waves transmitted from the above-described satellites are modulated by a modulation method according to the time of origin at which these radio waves are transmitted. The mobile terminal 101 can identify the time of origin at which the radio waves are transmitted by checking the modulation method of the received radio waves. Furthermore, based on a difference between the time of origin and the time of receipt, the mobile terminal 101 can also identify the time taken for the radio waves to reach the mobile terminal 101 from the satellites. Further, velocity of the radio wave is determined previously, and information of the velocity is stored in the mobile terminal 101. Therefore, the mobile terminal 101 can calculate the distance to the satellite by multiplying the time by the velocity. As described above, a position of the mobile terminal 101 is identified based on the calculated distance.

The CPU 111 may execute the calculation of a distance to the satellite and the identification of a position of the mobile terminal 101. Alternatively, the GPS communication unit 117 may include a processor aside from the CPU 111 to execute the calculation of the distance and the identification of the position through the processor.

When the mobile terminal 101 is a smartphone or a mobile phone, a function, such as a call function, can be realized by executing wireless communication between a communication unit (not illustrated) and a base station of a telephone line, so that the mobile terminal 101 can identify a distance between the mobile terminal 101 and the base station. Therefore, for example, a position which is identified by the radio waves from the satellites received by the GPS communication unit 117 can be corrected according to the distance between the mobile terminal 101 and the base station. In a case where the GPS communication unit 117 cannot receive the radio waves from the satellites, a position of the mobile terminal 101 may be identified according to the distances between the mobile terminal 101 and a plurality of the base stations. Furthermore, the position which is identified by the radio waves from the satellites received by the GPS communication unit 117 may be corrected based on an access point for the LAN port 113 to communicate with a printer via the network 103, or an internet protocol (IP) address allocated to the mobile terminal 101.

In the example illustrated in FIG. 1, the configuration in which the operation unit 112 and the display unit 115 are built into the mobile terminal 101 has been described. However, the configuration is not limited to the above, and external operation devices, such as a mouse and a keyboard, and an external display device may be connected to the mobile terminal 101.

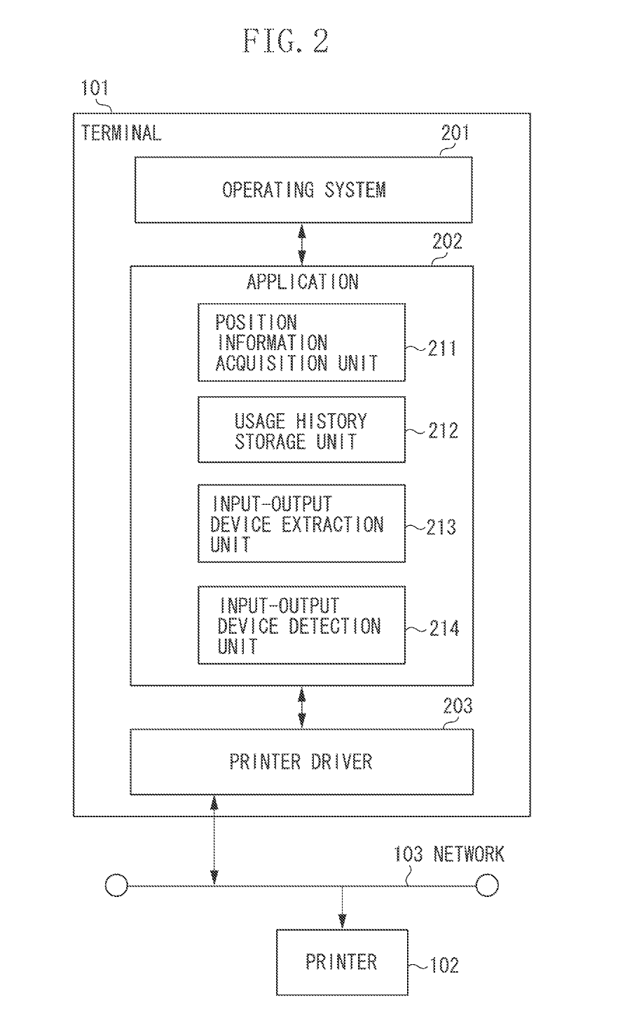

FIG. 2 is a diagram illustrating a software configuration of the mobile terminal 101. The mobile terminal 101 includes an operating system (OS) 201, an application 202, and a printer driver 203. These pieces of software are stored in the storage device 116, loaded onto the memory 114, and executed by the CPU 111.

The application 202 includes a position information acquisition unit 211, a usage history storage unit 212, an input-output device extraction unit 213, and an input-output device detection unit 214 as program modules.

The position information acquisition unit 211 acquires current position information (GPS information) by calculating a current position of the mobile terminal 101 based on the radio waves from the satellites received by the GPS communication unit 117 as described above. The usage history storage unit 212 stores, in the storage device 116, the GPS information acquired by the position information acquisition unit 211 and a printer corresponding to that GPS information as a usage history. Specifically, when a printing instruction is input by the user through the operation unit 112 and printing is executed by the printer, the usage history storage unit 212 associates the GPS information that is acquired at the time of receiving the printing instruction with the information indicating the printer, and stores that associated information in the storage device 116.

The GPS communication unit 117 and the position information acquisition unit 211, for example, periodically acquire the GPS information when the mobile terminal 101 is activated and operating. In a case where the GPS information is acquired periodically as described above, according to an instruction for executing printing input by the user, the GPS information which is acquired by the position information acquisition unit 211 immediately before or after receiving the instruction is stored in the storage device 116.

According to the present exemplary embodiment, when the application 202 searches for a printer, the position information acquisition unit 211 acquires current position information of the mobile terminal 101. Then, by referring to the usage history in the storage device 116 stored by the usage history storage unit 212, the application 202 identifies the printer that has previously received a printing instruction from the mobile terminal 101 in the vicinity of the current position of the mobile terminal 101. Then, as described below, the application 202 can display the information that indicates the identified printer on the display unit 115 as a printer for executing printing in a selectable manner. With the configuration described above, the user can appropriately select the printer which is previously used in the vicinity of the current position as a printer for executing printing.

As described above, in order to search for the printer, the input-output device extraction unit 213 acquires the usage history in the storage device 116 stored by the usage history storage unit 212. Then, the input-output device extraction unit 213 extracts a printer corresponding to the current position indicated by the GPS information from the acquired usage history. Thus, the printer which is previously used in the vicinity of the current position of the mobile terminal 101 is extracted.

The input-output device detection unit 214 detects whether the printer extracted by the input-output device extraction unit 213 exists in the same network 103 as that of the mobile terminal 101, and confirms that the printer is usable. In other words, in a case where the printer is turned off or offline with respect to the network 103, the printer is not detected by the input-output device detection unit 214. Therefore, through the detection executed by the input-output device detection unit 214, the application 202 can at least identify the device that is online with respect to the network 103.

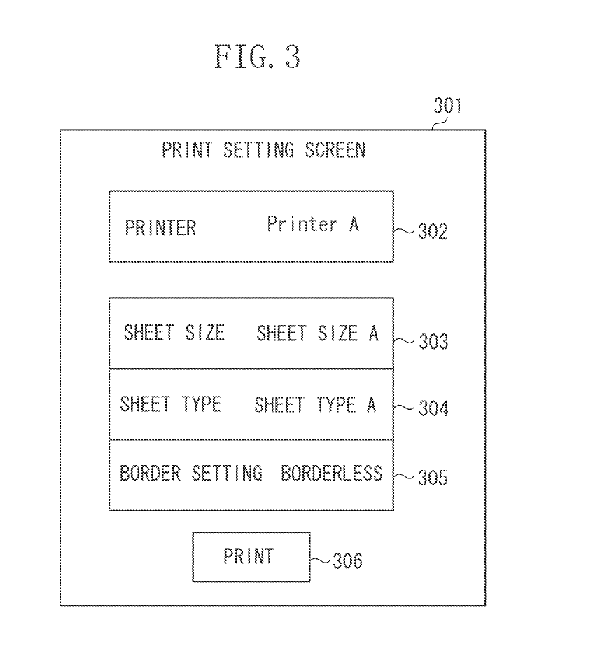

The printer driver 203 receives image data which is selected as a printing target by the user from the application 202, and changes the image data into a printable format to transmit the image data to the printer 102. At this time, the printer driver 203 provides a print setting screen illustrated in FIG. 3 to the user as a user interface (hereinafter, referred to as “UI”).

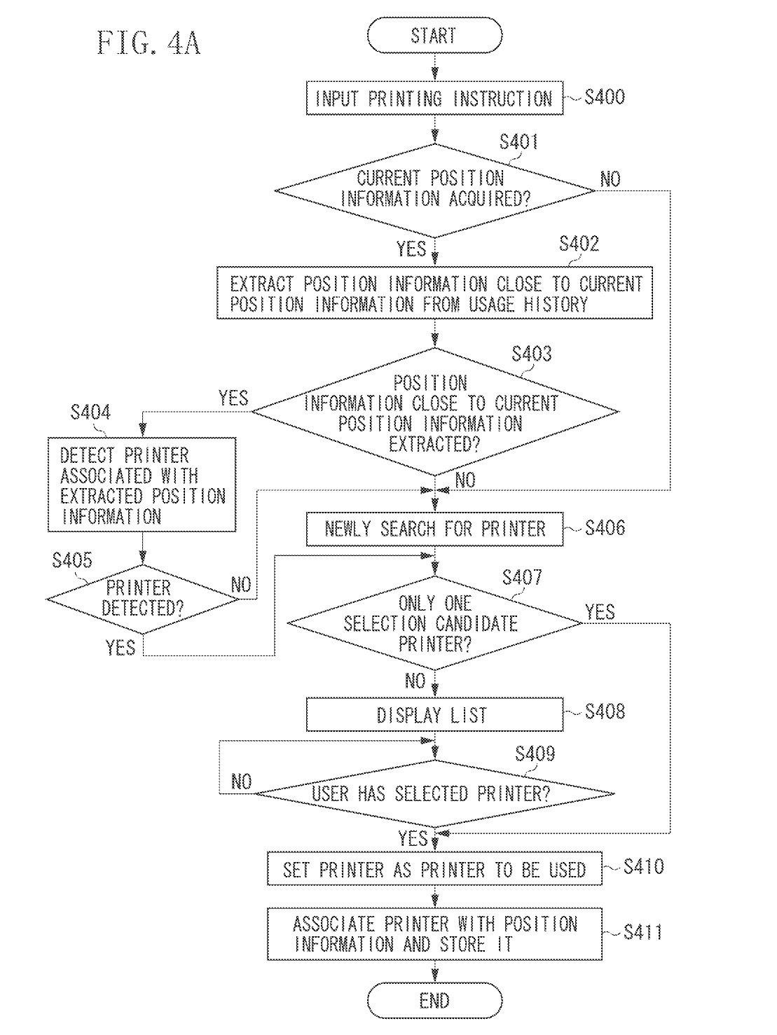

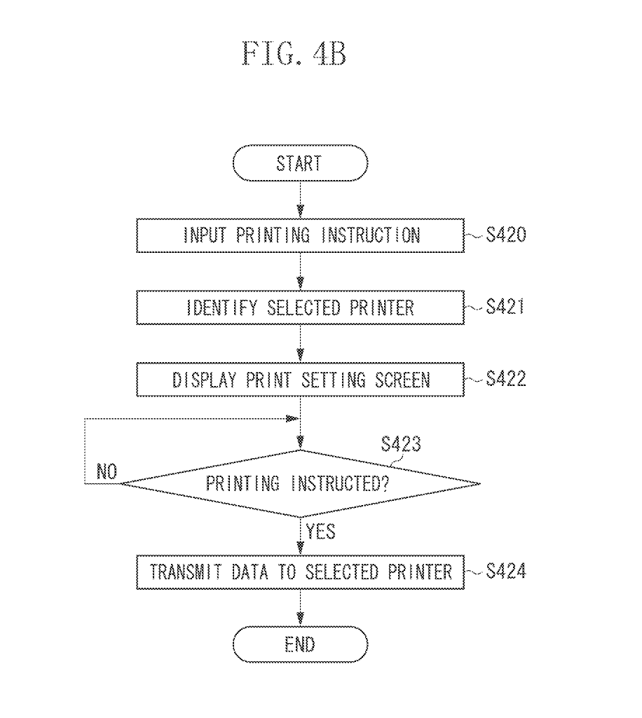

FIG. 3 is a diagram illustrating the print setting screen. A print setting screen 301 includes a printer button 302, a sheet size button 303, a sheet type button 304, and a border setting button 305. Information of the printer 102 which is set according to the processing flows illustrated in FIGS. 4A and 4B described below is displayed on the printer button 302. The user can manually select a printer other than the printer displayed thereon by using the printer button 302. The user can set a sheet size, a sheet type, and execution of “borderless printing” by the sheet size button 303, the sheet type button 304, and the border setting button 305 respectively. The term “borderless printing” is a printing method for printing an image that is larger than a sheet size set by the sheet size button 303 without having spaces on borders of the sheet. Then, by inputting an instruction through the operation unit 112 using the print button 306, the user can execute printing control so that a printer set to the printer button 302 is instructed to execute printing.

Various settings illustrated in FIG. 3 may be executed through a same screen illustrated in FIG. 3, or may be executed through a different screen at each type of setting. For example, when the user has selected a printer from a displayed printer selection screen, the screen may be switched to another screen for setting a sheet size and a sheet type with respect to the printer.

Further, in the example of FIG. 2, a description has been given to an example of the configuration in which the mobile terminal 101 includes a printer driver 203 so that the printer driver 203 converts data created by the application 202 into printing data. However, the configuration is not limited to the above. For example, the mobile terminal 101 may not include the printer driver 203, so that the data created by the application 202, such as an image file in a joint photographic experts group (JPEG) format, may be transmitted to a printer without being converted into printing data. In this case, the printer itself executes rendering of data and conversion of data into printing data to execute printing. As described above, in a case where the mobile terminal 101 does not include the printer driver 203, the application 202 provides the printer selection screen illustrated in FIG. 3 and a screen for executing various print settings with respect to the printer.

FIGS. 4A and 4B are flowcharts each illustrating processing executed by the printing system according to the present exemplary embodiment. The flowchart of FIG. 4A illustrates processing from a procedure for acquiring the GPS information to a procedure for setting the printer to be used which is executed by the application 202. The processing illustrated in FIGS. 4A and 4B is realized when the CPU 111 reads the programs corresponding to the OS 201 and the application 202 from the storage device 116 and executes the programs on the memory 114.

In step S400, a user inputs a printing instruction to the application 202 via the operation unit 112. For example, the printing instruction is input when the user uses the operation unit 112 to input an instruction through the print button 306 that is displayed on the display unit 115 by the application 202.

When the printing instruction is input in step S400, in step S401, the position information acquisition unit 211 requests the OS 201 to provide the GPS information as current position information of the user, and determines whether the current position information is acquired. The current position information includes the information, such as latitude, longitude, and altitude which are acquired as the GPS information. In step S401, the position information acquisition unit 211 acquires the GPS information that is received by the GPS communication unit 117 according to the above-described request. Alternatively, in a case where the GPS communication unit 117 periodically receives the GPS information, the position information acquisition unit 211 may acquire the GPS information that has been received immediately before or after the above-described request. Further, processing in step S401 may be executed repeatedly for a certain number of times until the GPS information is acquired. Then, in a case where the GPS information cannot be acquired even if the processing in step S401 has been executed for a certain number of times, the position information acquisition unit 211 may determine that the GPS information cannot be acquired.

In step S401, if the position information acquisition unit 211 determines that the GPS information of the current position is acquired (YES in step S401), the processing proceeds to step S402.

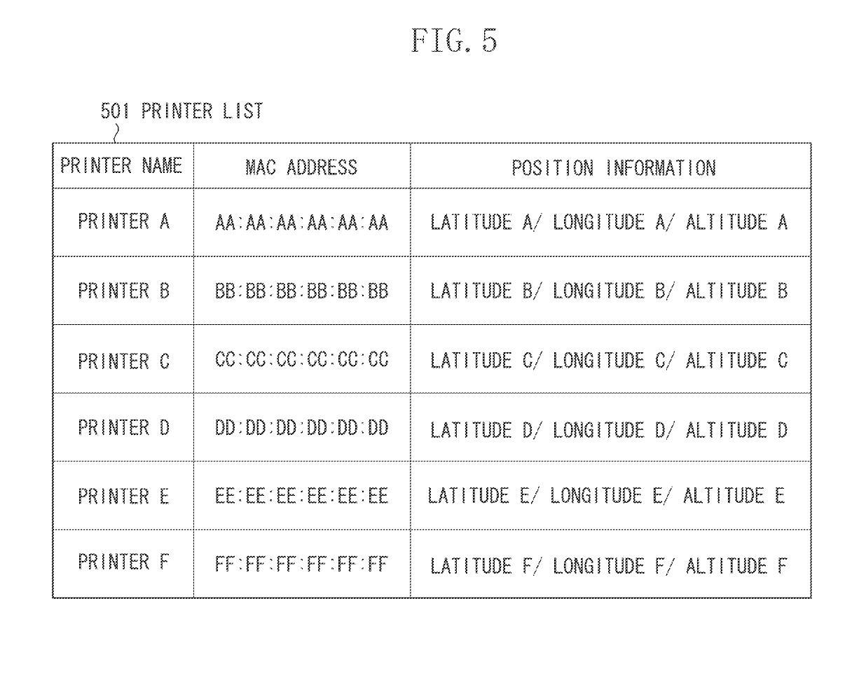

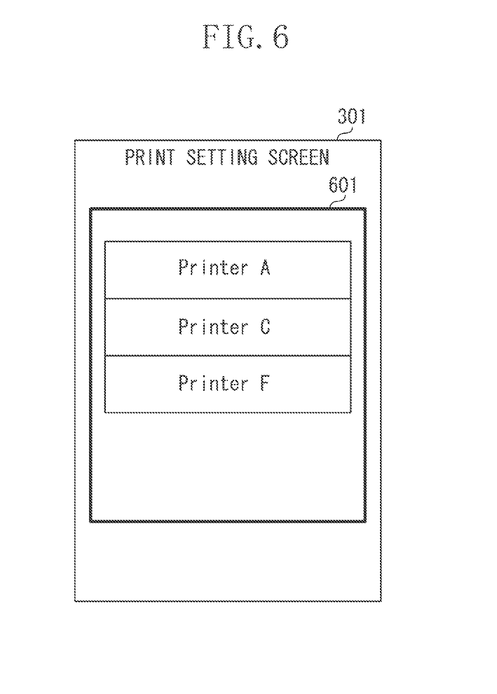

In step S402, the input-output device extraction unit 213 of the application 202 acquires a usage history stored in the usage history storage unit 212. Then, the input-output device extraction unit 213 extracts, from the acquired usage history, the position information that is close to the current position indicated by the GPS information acquired in step S401. The input-output device extraction unit 213 then identifies a printer that is associated with the extracted position information. Specifically, in step S402, the input-output device extraction unit 213 identifies the printer from a printer list 501 illustrated in FIG. 5.

FIG. 5 is a diagram illustrating an example of the printer list in the storage device 116 stored by the usage history storage unit 212. Through the processing of step S411 as described below, the usage history storage unit 212 stores, in the printer list, a name of the printer, a media access control (MAC) address as device information for identifying the printer, and latitude, longitude, and altitude as the position information indicating a place where the printer is used.

In step S402, from the printer list 501 illustrated in FIG. 5, the input-output device extraction unit 213 identifies a printer corresponding to the position information that is close to the current position acquired in step S401. Specifically, the input-output device extraction unit 213 identifies a printer which corresponds to the position information indicating a distance from the current position to the printer shorter than a predetermined distance. In step S402, the predetermined distance for determining that the printer is in the vicinity of the current position can be determined to be a distance that is kept within a range formed of a sphere having the position indicated by the position information acquired in step S401 at the center thereof. A fixed value may be applied to a radius of the sphere. Alternatively, a variable value for fluctuating the above-described range for determining whether the printer is close to the current position, depending on the accuracy of the GPS information, may be applied to the radius thereof.

In step S403, if the application 202 determines that the corresponding position information does not exist in the printer list 501 (NO in step S403), the processing proceeds to step S406. For example, when the user provides a printing instruction at the current position for the first time, a result of determination in step S403 is “NO” so that the processing proceeds to step S406. When the position information cannot be acquired in the above-described step S401 (NO in step S401), the processing also proceeds to step S406.

In step S406, the application 202 newly searches for a printer on the network 103 and the processing proceeds to step S407 which will described below. In a case where any printer cannot be found in step S406, an error message indicating that none of the printer is found is displayed on the display unit 115. Alternatively, the application 202 may execute processing for detecting a new printer until the user provides a cancellation instruction.

In step S403, in a case where the application 202 determines that the corresponding position information exists in the printer list 501 (YES in step S403), the processing proceeds to step S404. In a case where a result of determination is “YES” in step S403, the application 202 can determine that the printer identified in step S403 is the printer which is previously used in the vicinity of the current position.

In step S404, the input-output device detection unit 214 checks that the printer is online by communicating with the printer to check the response from the printer. In step S405, the application 202 confirms whether the printer has been detected in step S404. For example, in a case where the printer is turned off or offline at the time of the processing in step S404 or the printer has been relocated after the last printing operation, there may be a case where the printer does not exist in the network 103 at the point of time. In such a case, because the printer is not detected in step S404 and cannot be used at the point of time, in step S405, the application 202 confirms whether the printer has been detected.

In step S405, if the application 202 confirms that the printer has been detected in step S404 (YES in step S405), the processing proceeds to step S407. Thereafter, in step S410, the application 202 sets the printer as a printer to be used. In a case where the application 202 cannot confirm the detection of the printer (NO in step S405), the application 202 determines that at least the printer cannot be used at the point of time and the processing proceeds to step S406. Then, in step S406, the application 202 executes the above-described processing to search for a new printer.

In step S407, the application 202 determines whether only one printer is found in step S403 or detected in step S404 as a selection candidate. When it is determined that a printer as a selection candidate is more than one (NO in step S407), the processing proceeds to step S408, because a plurality of printers is found or detected as the selection candidates. When it is determined that a printer as a selection candidate is only one (YES in step S407), the processing proceeds to step S410.

In step S408, the application 202 displays a list of a plurality of the selection candidate printers on the display unit 115 in order to allow a user to select a printer that is to be used for the printing operation from among a plurality of the selection candidate printers.

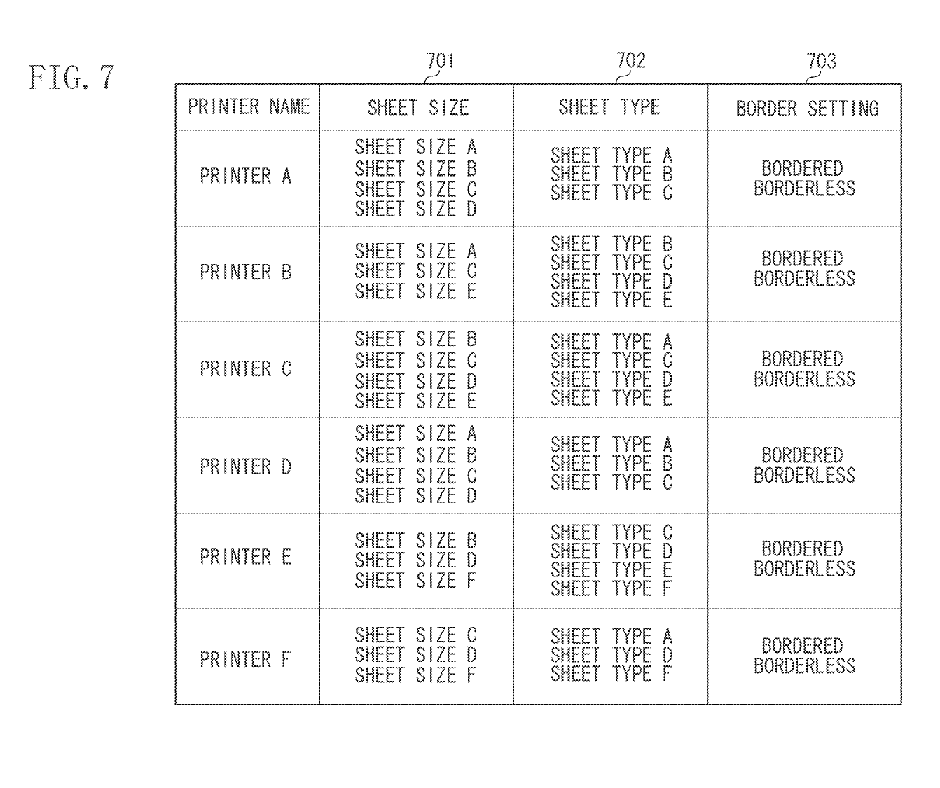

FIG. 6 is a diagram illustrating an example of the list that is to be displayed on the display unit 115 in step S408. This list is displayed by the application 202. The user can select a printer that is to be used for the printing operation from a printer selection list 601 by using the operation unit 112.

In the example illustrated in FIG. 6, names of a plurality of the selection candidate printers are displayed in the order corresponding to the order of the printer list 501. However, the display order is not limited to the above. For example, the usage history storage unit 212 may store the number of usage times and the usage time and date in the storage device 116. Then, among a plurality of the selection candidate printers, a printer with the greatest number of usage times, or a printer with the latest usage time and date may be displayed at the highest order of the printer selection list 601. Alternatively, an icon indicating the printer with the greatest number of usage times or the latest usage time and date may be added to a name of the printer. With the above-described method, the user can recognize which printer from among the selection candidate printers is used frequently and recently. Further, the selection candidate printers may be provided through other method, such as an audio output method, instead of displaying the printer selection list 601 on the display unit 115.

In step S409, the application 202 determines whether the user has selected the printer from the list displayed in step S408 via the operation unit 112. If the user has selected the printer (YES in step S409), the processing proceeds to step S410. If the user has not selected the printer (NO in step S409), the application 202 waits until the user selects the printer.

In step S410, the application 202 sets either the printer selected by the user in step S409 or the printer determined to be the only one selection candidate in step S407 as the printer that is to be used according to the printing instruction input in step S400.

In step S411, the usage history storage unit 212 executes storage control in which the position information acquired in step S401, and the printer detected in step S404 or S406 so as to be set in step S410 are associated with each other and stored in the printer list 501 within the storage device 116.

In the above-described extraction processing executed in step S402, the application 202 refers to the information stored in the printer list 501 through the processing in step S411. The printer list 501 is thus updated every time the printer is used. Therefore, the printer stored in step S411 also becomes a candidate of the extraction processing in step S402 for the next printing instruction.

Further, in a case where the printer that is already included in the printer list 501 is extracted in step S404, position information of the current position acquired in step S401 is additionally stored in the printer list 501 in step S411. However, the operation in step S411 is not limited to the above. Although the storage processing is executed on the printer newly detected in step S406, the storage processing may not be executed on the printer extracted from the printer list 501 in step S404.

The flowchart illustrated in FIG. 4B will be described. The processing of the flowchart illustrated in FIG. 4B is executed by the printer driver 203 after the application 202 executes the processing illustrated in FIG. 4A. The processing illustrated in FIG. 4B may be executed by the application 202 if the mobile terminal 101 does not include the printer driver 203.

In step S420, the printer driver 203 receives a printing instruction for activating the printer driver 203 from the application 202.

In step S421, the printer driver 203 acquires the information indicating the printer which is set by the application 202 in step S410 (such as the information included in a list illustrated in FIG. 5) from the application 202 so as to identify the printer. In a case where the processing of FIG. 4B is executed by the application 202, in step S421, the printer that is set by the application 202 itself in step S410 is identified.

In step S422, the printer driver 203 displays the print setting screen 301 illustrated in FIG. 3 on the display unit 115. At this time, a name of the printer set in step S421 is displayed on the printer button 302 which indicates a name of the printer. The name is included in the information acquired from the application 202 in step S421.

Through the printer button 302 illustrated in FIG. 3, according to the instruction from the user, the printer set in step S421 may be changed to other printer. For example, names of the printers included in the printer list 501 stored in the storage device 116 are displayed on the print setting screen 301 illustrated in FIG. 3 as the selection candidates. Furthermore, through the buttons 303 to 305 illustrated in FIG. 3, the user can execute various print settings, such as a size, a type, and a border setting of the sheet to be printed.

In step S423, the printer driver 203 determines whether the user has input an instruction through the print button 306 of the print setting screen 301 illustrated in FIG. 3. When the instruction is input through the print button 306 (YES in step S423), the processing proceeds to step S424. If the instruction is not input (NO in step S423), the printer driver 203 waits for the user's instruction.

In step S424, the printer driver 203 transmits data of a printing target created by the application 202 and print setting information set through the print setting screen 301 illustrated in FIG. 3 to the printer to be used for printing. Specifically, the printer driver 203 acquires a MAC address of the printer that is selected when the instruction is input to the print button 306, from the storage device 116 as the device information for identifying the printer. Then, the printer driver 203 transmits the data to the selected printer by using the MAC address. As described above, the CPU 111 can execute the printing control for executing printing through the printer.

According to the processing illustrated in FIGS. 4A and 4B, a previously-used printer is automatically identified at the position where the user has instructed printing, so that the user can execute the printing operation through the printer. Therefore, in the environment where a plurality of printers is installed, the user can easily select a printer that has been used for the previous printing operation as a printer for executing the current printing operation.

Specifically, for example, usable functions may vary in every printer. Therefore, the previously-used printer may desirably be selected easily when the user would like to acquire the same printing result as in the photo-printing operation that has been executed in the past, or when the printer that can be used by the user is restricted. Further, in a case where the printer is away from the position where the user instructs printing, the user may have difficulty in collecting the sheet on which printing is executed. According to the present exemplary embodiment illustrated in FIGS. 4A and 4B, the user can easily select the previously-used printer in the vicinity of the position where the user instructs printing. Therefore, as described above, the user can select the appropriate printer in a case where the user would like to execute the printing operation through the printer in the vicinity of the user by employing the printing function that has been used in the past.

According to the present exemplary embodiment, the previously-used printer in the vicinity of the user can be detected automatically. Therefore, for example, the user who uses a specific printer in a specific environment can select the printer easily and appropriately even if the user does not select the printer at every printing operation, or the user does not register the printer as a regularly-used printer.

According to the processing illustrated in FIGS. 4A and 4B, in a case where the printer which has been previously used by the user at the current position is identified, the identified printer has been designated as a selection candidate of the current printing operation. However, another printer on the network 103 may be also selected by the user. In a case where the user selects another printer as described above, the usage history storage unit 212 stores the GPS information of the current position and the information of another printer in the storage device 116 as described in step S411. When the user instructs printing at the position next time, that another printer is extracted from the printer list 501 in step S404.

As described above, according to the present exemplary embodiment, a printer that has been used in the past at the current position of the mobile terminal 101 is identified automatically. Therefore, in a case where the user has selected a printer in the vicinity of the current position, even if that printer does not have a GPS function, the printer in the vicinity of the current position can be selected easily.

In the present exemplary embodiment, a printer has been described as an example. However, the exemplary embodiment is not only applicable to the printer, but also applicable to various devices, such as a scanner, a facsimile machine, and a multifunction peripheral that includes both the printer and the scanner.

According to the present exemplary embodiment, as the condition for identifying the device to be used, the current position information of the terminal and the position information of the device of when the device is used have been employed. In addition to the above condition, capability information may be also employed as the functional information for identifying the function of each device.

FIG. 7 is a diagram illustrating capability information of printers stored in the storage device 116. As illustrated in FIG. 7, capability information of each printer is associated with a name of printer and stored. In FIG. 7, pieces of information 701 to 703 illustrate examples of the capability information of the printers, which include the information, such as a sheet size, a sheet type, and a border setting that can be used by the printers.

The capability information illustrated in FIG. 7 is referred to when a candidate of the printer used for the current printing operation is identified through the processing illustrated in FIGS. 4A and 4B. Specifically, in step S400 illustrated in FIG. 4A, when the user inputs a printing instruction using the operation unit 112 while looking at the display provided on the display unit 115, the user also inputs a sheet size, a sheet type, and a border setting together with the printing instruction. For example, the application 202 displays a screen for executing various settings, such as a screen of the printer driver illustrated in FIG. 3.

Then, through the processing in steps S402, S403, and S404 illustrated in FIG. 4A, the application 202 identifies a printer previously used at the current position of the mobile terminal 101, which includes the capability information corresponding to the function specified by the user. With the above-described operation, a printer having the function desired by the user can be identified. Furthermore, a printer as a target of the detection processing in step S404 can be limited to the printer having the capability information.

The capability information is not limited to the example illustrated in FIG. 7, but can be the information indicating capability and incapability of other functions, such as a color printing function. If the device is a scanner, the capability information may be presence or absence of an automatic document feeding device or capability or incapability of a two-sided scanning function. Alternatively, the capability information may be the information for identifying whether the device includes a printing function or a scanning function.

A function for narrowing down the devices through the capability information does not have to be specified by the user. For example, in a case where the user operates the application 202 to select a photograph in order to execute photo-printing, a device the user would like to use can be determined as a printer. Therefore, the input-output device extraction unit 213 can narrow down the device that is to be extracted from the printer list 501 to a printer. In such a case, because the purpose of the user is to execute photo-printing, the device may be narrowed down to a printer capable of executing color printing, or may be further narrowed down to a printer capable of executing borderless printing.

Further, according to the present exemplary embodiment, the GPS information is used as the position information of the mobile terminal 101. However, other information capable of identifying the current position information or the network environment can be also used. Specifically, a name of the access point to which the printer and the mobile terminal 101 are connected may be used.

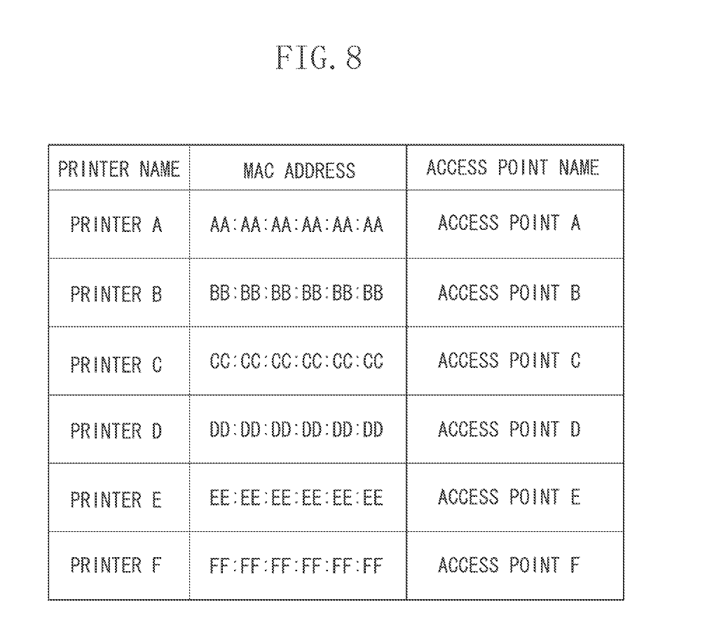

FIG. 8 is a diagram illustrating names of the access points corresponding to the printers stored in the storage device 116. As illustrated in FIG. 8, the access point to which the previously-used printer has been connected is associated with a name of the printer and stored. In step S402 illustrated in FIG. 4A, the printer corresponding to the access point through which the mobile terminal 101 currently connects to the printer is extracted from the usage history.

In FIGS. 5 and 8, the MAC address is used as the printer information. However, other information capable of identifying the printer, such as the IP address may be also used as the printer information.

According to the processing illustrated in FIG. 4A, in step S402, after the application 202 has identified the previously-used printer which corresponds to the GPS information of the current position, in steps S404 and S405, the application 202 has determined whether the identified printer exists on the network 103. For example, in a case where a plurality of printers exists on the network 103, even if detection processing is executed on these printers, a number of the printers may not be selected because the printers do not correspond to the usage history. However, according to the processing illustrated in FIG. 4A, determination as to whether the printer exists on the network 103 is executed after the filtering processing is executed based on the condition that the printer should be previously used in the vicinity of the current position. Therefore, it is possible to limit the printers that are to be the processing target of the detection processing.

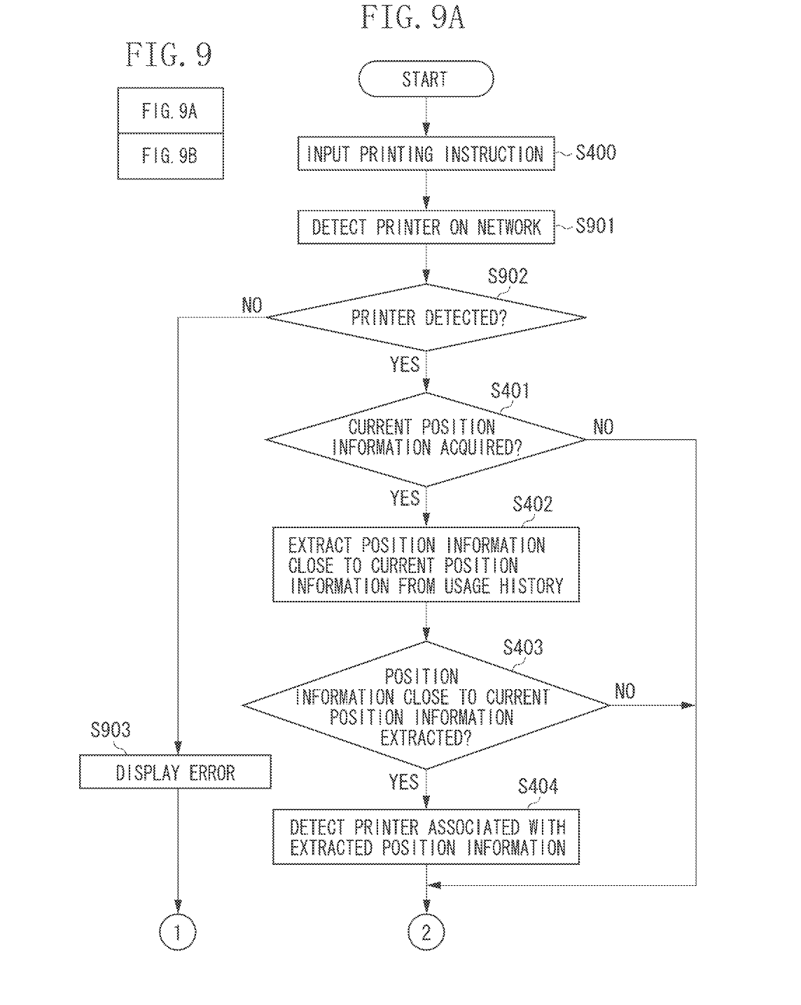

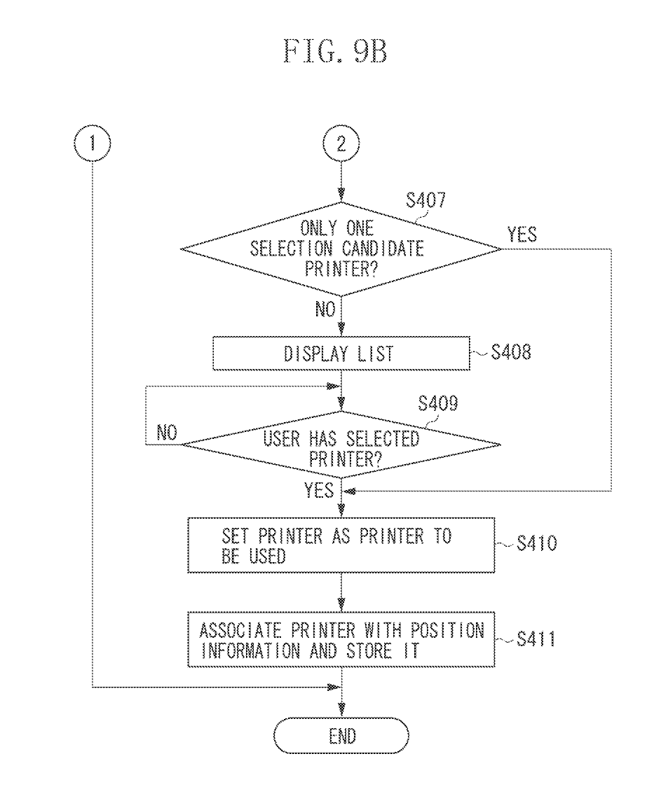

However, the identification method is not limited to the above-described method. The application 202 may firstly detect the printers on the network 103, and then, the application 202 may identify the previously-used printer which corresponds to the current position from among the detected printers. With this method, the printer which is previously used at the current position, which also exists in the network 103 at this moment, can be also identified. The method will be described with reference to FIG. 9. In the flowchart illustrated in FIG. 9, a description of the processing common to those described in the flowchart illustrated in FIG. 4A will be omitted.

Similar to the flowchart illustrated in FIG. 4A, a program corresponding to each step of the processing illustrated in FIG. 9 is stored in the storage device 116. Then, the processing illustrated in FIG. 9 will be realized when the CPU 111 executes the program on the memory 114.

In step S400 illustrated in FIG. 9, similar to the processing executed in step S400 illustrated in FIG. 4A, a printing instruction is input by the user.

In step S901, the application 202 detects the printer existing on the network 103. With this processing, the application 202 can detect the printer that is online at this moment as a candidate of the printer for executing printing according to the printing instruction.

In step S902, the application 202 determines whether the printer is detected in step S901. In step S902, in a case where it is determined that the printer on the network 103 is not detected (NO in step S902), the processing proceeds to step S903. In step S903, the application 202 displays an error message indicating that no printer is detected on the display unit 115, and ends the processing.

On the other hand, in a case where the printer on the network 103 is detected (YES in step S902), the processing proceeds to step S401. In step S401, in a case where it is determined that the current position information is acquired (YES in step S401), the processing proceeds to step S402. In step S402, the application 202 extracts the position information close to the position indicated by the acquired current position information from the printer list 501 stored in the storage device 116. In step S402, the printer which is determined by the application 202 whether the position information is close to the current position is limited to the printer detected in step S901. The processing that are to be executed in the following steps of S403, S404, and S407 through S411 are the same as those described in FIG. 4A, and thus the description thereof will be omitted.

According to the processing of the flowchart illustrated in FIG. 9, the application 202 detects the printer on the network 103 before referring to the usage history in step S402. Then, the application 202 refers to the usage history so that the target of the determination processing as to whether the position information is close to the current position can be limited to the printer detected by the above detection processing. Therefore, for example, even in a case where a number of the printers are used at the current position previously, the appropriate printer can be identified easily if the comparison processing of the position information in step S402 is executed by limiting the printers to those exist on the network 103.

In step S402 illustrated in FIG. 9, similar to the processing described in FIG. 4A, the printers can be narrowed down by using the capability information of the printers described with reference to FIG. 7, or the printer may be extracted by using the access point described with reference to FIG. 8.

Further, in step S408 illustrated in FIGS. 4A and 9, when a list of selection candidate printers is displayed, an order of the printers in the list may be determined based on various conditions. For example, names of the selection candidate printers may be displayed in the order of the latest (or the oldest) date of usage. For this purpose, with respect to the printer that is selected by the user as a printer for executing printing, the usage history storage device 212 stores the selected date in the storage device 116.

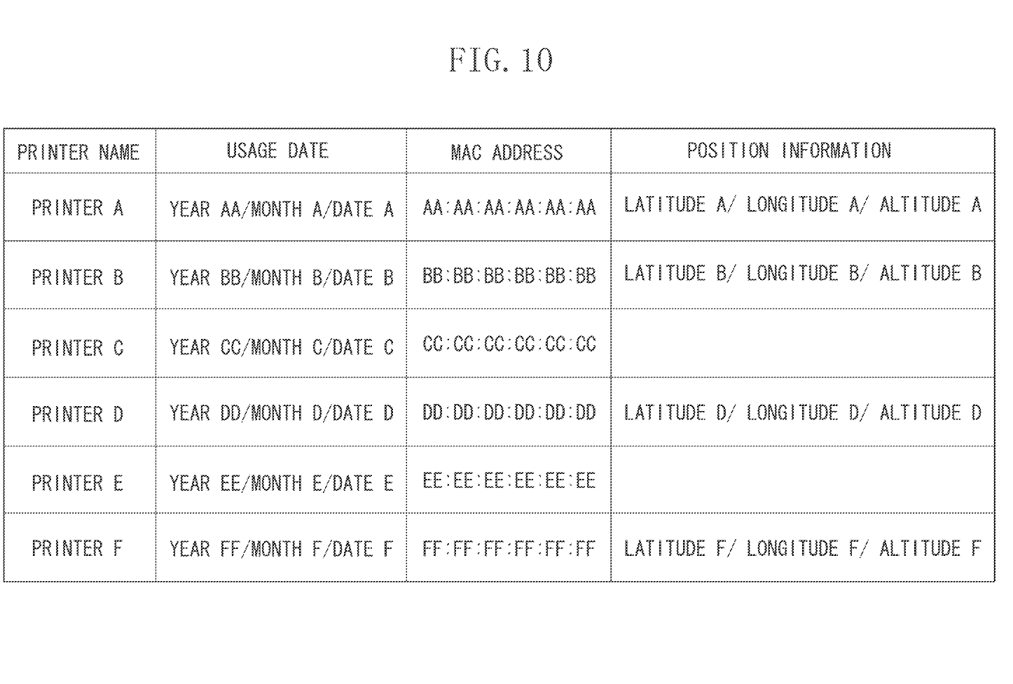

FIG. 10 is a diagram illustrating an example of a printer list. In comparison to the printer list 501 illustrated in FIG. 5, the printer list includes information on printer's date of usage in addition to the name of the printer, the MAC address of the printer, and the position information of the mobile terminal 101. When the printer executes printing, the usage history storage unit 212 overwrites the date of usage illustrated in FIG. 10 with that date.

Then, in step S408, names of a plurality of the selection candidate printers are sorted and displayed as a list in the order of the latest date (or the oldest date) of usage.

The usage history storage unit 212 may store printer's time and date of usage instead of printer's date of usage. Further, in the examples described in FIGS. 5, 7, and 8 in addition to the example of FIG. 10, the usage history storage unit 212 may store the usage history in the storage device 116 in a case where the user selects a printer through a method other than the selection method of the printer executed by the processing of FIGS. 4A and 9.

Furthermore, in a case where the printer cannot be detected in step S404 of FIG. 4A or step S902 of FIG. 9, for example, the printer may be relocated from the installation site where the printer is used previously, or the printer may be offline at this moment. However, relocation of the printer is assumed to be comparatively less frequent. Therefore, in a case where the printer cannot be detected, the application 202 may cause the display unit 115 to display a screen prompting the user to check if the printer that is previously used at this position is online. Then, in the above-described screen, for example, the application 202 may display a “re-search” button to execute detection of the printer again when the button is pressed by the user. With such a configuration, when the user is notified of the above screen to turn on the printer or bring the printer to an online state, the printer can be detected appropriately.

Further, in a case where the printer on the network 103 is detected in step S404 of FIG. 4A or step S902 of FIG. 9, the application 202 may acquire status information indicating a status from the printer. Then, in a case where the status of the printer is an error state, the application 202 can advise the user to solve the error state.

For example, when the printer is uniquely identified and that printer is in the error state, an error display indicating the error state may be displayed on the display unit 115. Further, in a case where a plurality of the printers is listed and displayed as described in step S408, information indicating the error state, such as an icon or gray-out processing, may be added or applied to the name of the printer in the error state. Alternatively, a name of the printer in the error state may be placed at a lower order of the list by lowering the priority level thereof, or the printer in the error state may be excluded from the list.

Furthermore, when the above-described display processing is to be executed, the application 202 may also display a type of error in addition to indicating that the printer is in the error state. Therefore, the above-described status information also indicates a type of error in addition to indicating that the printer is in the error state. For example, when the application 202 is notified that the printer has run out of printing paper, the application 202 advises the user to supply the printing paper. Further, when the application 202 is notified of shortage of recording materials, such as ink or toner, the application 202 may display a message prompting the user to replace an ink cartridge or a toner cartridge.

By executing the above display processing, if the printer has run out of printing paper, for example, the user can choose whether to supply the printing paper or to newly search for another printer. In FIG. 4A, if the user chooses to search for a new printer, for example, the processing of the application 202 proceeds to step S406, so that the application 202 newly searches for a printer. In the above example, although the application 202 prompts the user to choose whether to supply printing paper or to search for another printer, the application 202 can newly search for a printer automatically without asking the user to make a choice.

According to the present exemplary embodiment, the usage history storage unit 212 stores the position information or the name of the access point as illustrated in FIGS. 5, 8, and 10. The usage history storage unit 212 may overwrite the usage history with the position information or the name of the access point corresponding to the new printing operation, or may additionally store a plurality of pieces of position information or the names of a plurality of access points with respect to one printer in the usage history. In a case where the usage history storage unit 212 additionally stores the position information or the name of the access point, when the application 202 extracts a printer next time, the application 202 extracts the printer as a selection candidate if any of a plurality of pieces of the position information or the names of a plurality of the access points stored in the usage history corresponds to the position information of the mobile terminal.

According to the present exemplary embodiment, as described in step S402, a printer in which the distance between the printer and the mobile terminal 101 is kept within a predetermined range has been identified. However, it is not limited to the above. For example, the printer for executing printing may be identified by comparing each of the distances between the mobile terminal 101 and printers. For example, the application 202 may identify the printer in the closest vicinity of the mobile terminal 101 to provide the printer to the user. Alternatively, the application 202 may display the names of the printers on the print setting screen illustrated in FIG. 6 in the order of the shortest distance by comparing each distance between a printer, the names and the device information of which are included in the printer list 501, and the mobile terminal 101 with each other.

According to the present exemplary embodiment, predetermined processing executed by the mobile terminal 101 through the device has been printing processing, and the device serving as a search target has been an image processing apparatus, such as a printer, a scanner, a facsimile machine, or a multifunction peripheral. However, the processing and the search target device are not limited to the above, and the present exemplary embodiment is also applicable to a case where various kinds of processing, such as display processing are executed by various devices, such as a display device of a television and a projector according to an execution instruction from the user. In a case where the present exemplary embodiment is applied to a display device, position information of the mobile terminal and the device information, such as a MAC address, an IP address, or a serial number for identifying the display device are stored as a usage history. With the above-described configuration, according to the place where the mobile terminal 101 is used, the mobile terminal 101 extracts the display device previously used in the place from the usage history and provides the user with the display device by detecting the extracted display device as a regularly-used display device. As described above, in a case where the present exemplary embodiment is applied to a display device, the GPS information and the name of the access point can be also used as the position information. Further, a method described with reference to FIG. 7 can be applied by collectively storing the information indicating an image size and definition as the capability information. Furthermore, as another example of the device, the present exemplary embodiment is also applicable to an audio device, such as a speaker. In this case, sound volume and sound quality setting of the speaker can be used as examples of the capability information.

Further, according to the exemplary embodiment, a printer that is to be used for printing has been identified according to the position of the mobile terminal 101 identified by the GPS function included in the mobile terminal 101. However, the configuration is not limited to the above. For example, each of the printers on the network 103 may include the GPS function similar to that included in the mobile terminal 101 according to the present exemplary embodiment. In this case, for example, when the mobile terminal 101 searches the network 103 for printers, the position information of each printer identified by the GPS function of the printer is transmitted to the mobile terminal 101. Then, the mobile terminal 101 can identify the printer positioned in the vicinity of the mobile terminal 101 by comparing the position of the mobile terminal 101 and the position of each printer.

Alternatively, in a case where the mobile terminal 101 provides a printing instruction to the printer, position information which indicates a position of the mobile terminal 101 at which the printing has been instructed may be transmitted to the printer. The position information is then associated with the mobile terminal 101 and stored in a memory included in the printer. When the mobile terminal 101 searches for the printer on the network, the above position information stored in each printer is transmitted to the mobile terminal 101. The mobile terminal 101 identifies the printer to which the mobile terminal 101 has previously provided a printing instruction and the position of the mobile terminal 101 at that point of time by referring to the position information corresponding to the mobile terminal 101. Then, by comparing the position of the mobile terminal 101 for newly providing a printing instruction with the above identified position, the mobile terminal 101 can identify the printer to which the mobile terminal 101 has instructed printing in the past in the vicinity of the position where the mobile terminal newly provides the printing instruction.

Further, according to the present exemplary embodiment, as described in step S400 of FIG. 4A, for example, the mobile terminal 101 has executed search processing of the printer according to the printing instruction from the user. However, it is not limited to the above, and the search processing may be executed according to a search instruction of a printer provided by the user. In this case, the printer which is detected by the processing according to the present exemplary embodiment will be provided to the user through the display unit 115 and the like. Then, the printer executes printing when the user selects that printer to provide a printing instruction.

Further, an instruction from the user is not limited to the above-described printing instruction or search instruction. For example, the printer search processing according to the present exemplary embodiment may be executed according to an activation instruction of the application relating to the printing operation. Furthermore, as described above, a search target according to the present exemplary embodiment is not limited to a printer but may be various devices, such as a monitor. In such a case, the device search processing according to the present exemplary embodiment may be executed according to an instruction for activating the application that uses the various devices.

Further, for example, the device search processing according to the present exemplary embodiment may be executed when the mobile terminal 101 is turned on according to an activation instruction of the mobile terminal 101 provided by the user.

The mobile terminal may periodically search for the device when the mobile terminal is ON, or may automatically search for the device at various timings in addition to searching for the device according to the user's instruction. In this case, the mobile terminal may provide the user with the searched device whenever the device is found automatically, or may provide the user with the device that has been found automatically when the application capable of using the device is activated.

Further, according to the present exemplary embodiment, in response to the printing instruction from the user, the printer previously used for printing at the position corresponding to the printing instruction has been identified. However, the function instructed by the user may not be the same as the function that has been executed previously. For example, in a case where the device as a search target is an apparatus for executing a plurality of functions, such as printing an image and reading a document, the device that has previously printed an image and/or the device that has previously read a document may be identified according to the printing instruction from the user. Alternatively, the device that has previously executed printing may be specified as the search target when the user provides a printing instruction, whereas the device that has previously read a document may be specified as the search target when the user provides a reading instruction. Specifically, when the device and the position information corresponding to the device are stored in the mobile terminal 101, the function executed by the device is associated therewith and stored in the mobile terminal. Then, when the user provides an instruction, the mobile terminal 101 refers to a function corresponding to the instruction and the above-described stored information, so as to be able to specify the device that has previously executed the function corresponding to the instruction as a search target. When the user provides a printing instruction, the user may be allowed to set whether to specify the device that has only executed document reading processing as a search target.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Further, a program code which realizes the functions of the present exemplary embodiment may be executed by a single computer such as a CPU or a micro processing unit (MPU), or may be cooperatively executed by a plurality of computers. Furthermore, the program code may be executed by a computer, and hardware, such as a circuit, for realizing the functions of the program code may be disposed thereon. In addition, a part of the program code may be realized by the hardware whereas the rest of the program code may be realized by the computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-248455 filed Nov. 29, 2013, which is hereby incorporated by reference herein in its entirety.

What is claimed is:

1. An information processing apparatus which controls a device to execute predetermined processing, the information processing apparatus comprising:
an acquisition unit configured to acquire position information for identifying a position of the information processing apparatus at which the information processing apparatus causes the device to execute the predetermined processing; and
an identifying unit configured to, after the predetermined processing is executed by the information processing apparatus according to a first control, and in a case where the predetermined processing is newly executed by the information processing apparatus according to a second control, identify a device for executing the predetermined processing according to the second control based on the position information corresponding to the first control acquired by the acquisition unit and position information of the information processing apparatus corresponding to the second control.

2. The information processing apparatus according to claim 1, wherein, in a case where a distance between a position identified by the position information corresponding to the first control and a position identified by the position information corresponding to the second control is shorter than a predetermined distance, the identifying unit identifies a device which has executed the predetermined processing according to the first control as a device for executing the predetermined processing according to the second control.

3. The information processing apparatus according to claim 1,
wherein the acquisition unit acquires the position information corresponding to the first control and device information for identifying a device corresponding to the position information, and
wherein the identifying unit identifies the device for executing the predetermined processing according to the second control based on the acquired position information, the acquired device information, and position information of the information processing apparatus corresponding to the second control.

4. The information processing apparatus according to claim 1, further comprising:
a presentation unit configured to provide a plurality of devices to a user in a case where a plurality of the devices is identified by the identifying unit,
wherein the identifying unit further identifies a device selected by a user from among the plurality of the devices provided by the presentation unit.

5. The information processing apparatus according to claim 1, further comprising:
a storage control unit configured to store position information of the information processing apparatus at which the information processing apparatus causes the device to execute the predetermined processing in a memory,
wherein the acquisition unit acquires the position information stored in the memory by the storage control unit.

6. The information processing apparatus according to claim 5, wherein the storage control unit stores the position information of the information processing apparatus at which the information processing apparatus causes the device to execute the predetermined processing in a memory included in the information processing apparatus or a memory included in the device.

7. The information processing apparatus according to claim 1,
wherein the acquisition unit acquires position information corresponding to the device and functional information for identifying a function of the device, and
wherein the identifying unit identifies the device based on a function corresponding to processing executed by the device and a function identified by the functional information acquired by the acquisition unit.

8. The information processing apparatus according to claim 1, wherein the predetermined processing is printing processing for printing an image on a print medium.

9. The information processing apparatus according to claim 1, wherein the predetermined processing is reading processing for reading a document.

10. The information processing apparatus according to claim 1, wherein, after the predetermined processing according to the first control is executed, and in a case where the second control is executed based on a new instruction from a user, the identifying unit identifies a device for executing the predetermined processing according to the second control.

11. The information processing apparatus according to claim 10, wherein the new instruction is an instruction for causing the information processing apparatus to execute the second control.

12. The information processing apparatus according to claim 10,
wherein the new instruction is an instruction for causing the identifying unit to identify a device for executing the predetermined processing according to the second control, and
wherein the identifying unit identifies the device by using position information of the information processing apparatus corresponding to the instruction as position information of the information processing apparatus corresponding to the second control.

13. The information processing apparatus according to claim 1, wherein, even in a case where a type of processing executed by a device as the predetermined processing according to the first control and a type of processing to be executed as the predetermined processing according to the second control are different from each other, the identifying unit is capable of identifying the device when the device is able to execute the processing that is to be executed according to the second control.

14. The information processing apparatus according to claim 1, wherein the identifying unit identifies a device for executing the predetermined processing according to the second control based on a condition that a type of processing executed as the predetermined processing according to the first control corresponds to a type of processing to be executed as the predetermined processing according to the second control.

15. The information processing apparatus according to claim 1, further comprising:
a receiving unit configured to receive position information of the information processing apparatus,
wherein the acquisition unit acquires the position information received by the receiving unit when the predetermined processing corresponding to the first control is executed.

16. The information processing apparatus according to claim 15, wherein the identifying unit executes the identification based on the position information received by the receiving unit when the predetermined processing corresponding to the second control is to be executed.

17. A control method of an information processing apparatus which controls a device to execute predetermined processing, the control method comprising:
acquiring position information for identifying a position of the information processing apparatus at which the information processing apparatus causes the device to execute the predetermined processing; and
identifying, after the predetermined processing according to a first control has been executed by the information processing apparatus, and in a case where the predetermined processing is newly executed by the information processing apparatus according to a second control, a device for executing the predetermined processing according to the second control based on the position information corresponding to the first control acquired by the acquiring and position information of the information processing apparatus corresponding to the second control.

18. A non-transitory computer-readable storage medium storing a program for causing a computer to execute the control method according to claim 17.
